(19) United States
(12) Patent Application Publication
(10) Pub. No.: US 2009/0069918 A1
(43) Pub. Date: Mar. 12, 2009

(54) PORTABLE DIGITAL DEVICE

(76) Inventor: Dong-Min SEO, Okcheon-gun (KR)

Correspondence Address: BIRCH STEWART KOLASCH & BIRCH, PO BOX 747, FALLS CHURCH, VA, 22040-0747, US

(21) Appl. No.: 12/205,527

(22) Filed: Sep. 5, 2008

(30) Foreign Application Priority Data
Sep. 5, 2007 (TW) 10-2007-0090122

(51) Int. Cl. G06F 17/00

(52) U.S. Cl. 700/94

(57) ABSTRACT

The present invention relates to a portable digital device. According to an embodiment, the method comprises a main unit including a display provided on the main unit and a terminal insertion portion; and an auxiliary unit including a terminal portion configured to be electrically connectable to the terminal insertion portion to allow communication between the main unit and the auxiliary unit, the auxiliary unit being configured to control operation of the main unit when being mounted to the main unit, the auxiliary unit being capable of independently reproducing audio and/or video data when being separated from the main unit.

### CROSS REFERENCE TO RELATED APPLICATIONS

The present application is related to, and claims priority to, Korean patent application 10-2007-0090122, filed on Sep. 5, 2007, the entire contents of which are hereby incorporated by reference.

### BACKGROUND OF THE INVENTION

1. Field of the Invention

The present invention relates to a portable digital device, and more particularly, to a portable digital device having an auxiliary unit that is separable from a main unit to be portable.

2. Description of the Related Art

Along with the development of multimedia technology, the demand on devices for playing back multimedia content is recently increased. Also, in order to easily utilize and appreciate various contents, there are recently proposed various portable devices capable of storing various kinds of multimedia data such that users may play back and utilize such multimedia data anytime at any place.

An MP3 player, which is a representative example of such devices, plays back music from received audio data. The MP3 player stores music data in a semiconductor memory, so that it can have a small size and also provide sound quality on a level with a CD.

Meanwhile, in order to cope with users' increased demand for multimedia contents, portable multimedia devices capable of playing back moving picture data such as AVI and MPEG as well as audio data such as MP3 are recently put on the market. A so-called portable multimedia player (PMP) is a representative example of the portable multimedia device. Unlike conventional MP3 players, the PMP may not only play back moving picture data as well as digital audio data such as MP3 but also have a large capacity storage therein, thereby being usefully utilized as a portable storage device.

However, such a conventional portable multimedia device has the following problems.

Due to the international trend of digital convergence technology in recent years, products in which various functions of an MP3 player or a PMP are mixed to a single portable digital device come out, but these products cause unexpected inconvenience to users in actual usage because of the increased size or heavy weight of the products.

In fact, a limit of battery capacity causes battery power to be consumed too early in a portable digital device capable of playing back MP3 or moving picture if its audio and video (A/V) functions are used unrestrictedly.

In addition, in case of PMP, which is spotlighted as the most advanced mobile device due to strong audio and video functions, it cannot catch up with a MP3 player from the viewpoint of portability.

Also, a user who desires to use only an MP3 player function on occasions should carry the heavy PMP, which causes large inconvenience from the viewpoint of use.

### SUMMARY OF THE INVENTION

The present invention is conceived to solve the aforementioned problems in the prior art. An object of the present invention is to provide a portable digital device, which has an auxiliary unit used not only as a configuration for manipulating the portable digital device but also as a configuration for supporting the portable digital device, wherein the auxiliary unit can be separated from the portable digital device to improve portability thereof.

According to an aspect of the present invention for achieving the objects, there is provided a portable digital device, which includes a main unit having a display for displaying an operation state provided on one surface thereof and a pivoting portion pivotally installed to one side thereof, wherein the pivoting portion is provided with a terminal insertion portion; and an auxiliary unit coupled to the pivoting portion to rotate together therewith, the auxiliary unit being provided with a terminal portion to be electrically connected to the terminal insertion portion, wherein the auxiliary unit controls operation of the main unit when being mounted thereto and is independently used when being separated from the main unit.

The terminal insertion portion provided in the pivoting portion may be electrically connected to a main board provided in the main unit.

The auxiliary unit may be provided with an input portion for controlling operation of the main unit so that the input portion is exposed in the same direction as the display when the auxiliary unit is mounted to the main unit, wherein the auxiliary unit has an earphone hole provided at a side opposite to the terminal portion to output a voice signal to the outside.

A touch pad may be provided in the input portion to selectively control operation of the main unit or the auxiliary unit.

A support may be provided at one side surface of the main unit to support the auxiliary unit at a position farthest from a pivot center of the auxiliary unit.

The support may be made of an elastically deformable material.

A concave portion and a protrusion inserted into the concave portion may be respectively formed in corresponding surfaces of the support and a body of the auxiliary unit that are in contact with each other.

An edge of a lower end of the body supported by the support may be formed to be round, and a friction member may be provided at the lower end of the body.

### BRIEF DESCRIPTION OF THE DRAWINGS

FIG. 1 is a perspective view showing a preferred embodiment of a portable digital device according to the present invention.

FIG. 2 is a plan view showing the portable digital device according to the present invention.

FIGS. 3a and 3c are perspective views showing operation states of the portable digital device according to the preferred embodiment of the present invention.

FIGS. 4 and 5 are perspective views showing another embodiment of the portable digital device according to the present invention.

FIG. 6 is a block diagram of a main unit and an auxiliary unit of the portable digital device according to the present invention.

FIG. 7 is a flowchart illustrating that the main unit is controlled by the auxiliary unit in the embodiment of the present invention.

### DESCRIPTION OF THE PREFERRED EMBODIMENT

Hereinafter, preferred embodiments of a portable digital device according to the present invention will be described in detail with reference to the accompanying drawings.

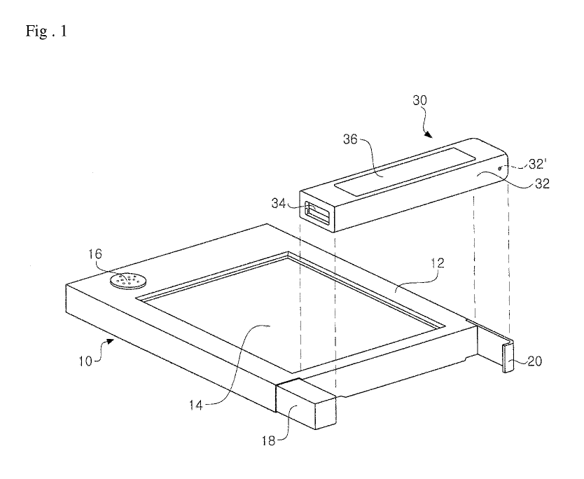

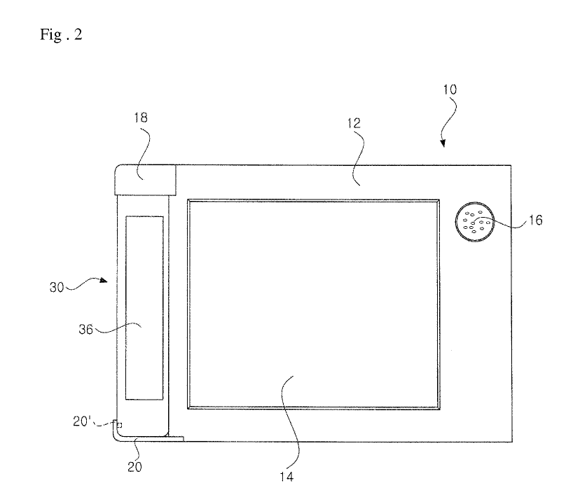

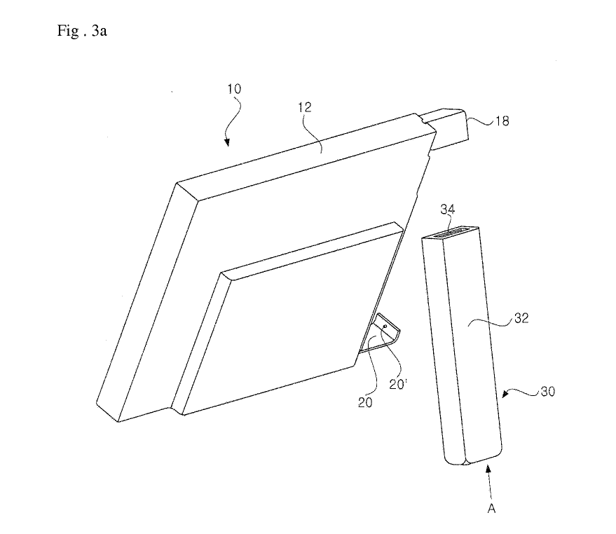

FIG. 1 is a perspective view showing a preferred embodiment of a portable digital device according to the present invention, and FIG. 2 is a plan view showing the portable digital device according to the present invention.

According to the figures, the portable digital device of this embodiment generally includes a main unit 10 and an auxiliary unit 30.

The main unit 10 has a function of a PMP widely used in these days. Unlike the auxiliary unit having only a music playback function, the main unit 10 may also play back a moving picture and has a large capacity storage to be usefully utilized as a portable storage device.

A case 12 defining an external appearance of the main unit 10 has a substantially hexahedral shape. The case 12 is provided with components required for operating the device, such as various memories (ROM and RAM), an interrupt controller and a battery.

A display 14 having a substantially tetragonal shape is provided in a front surface of the case 12. The display 14 has a liquid crystal display (LCD) panel and the like provided in the case 12, and a portion thereof is transparent such that contents displayed on the LCD panel may be viewed on the front of the case 12. The display 14 displays an operational state of the portable digital device or an image played by the execution of a multimedia file.

The main unit 10 may have an additional input portion for controlling the operation of the main unit 10. This input portion may include a touch pad or a button array having buttons for manipulation, and the display 14 may also be used as the input portion. For example, the display 14 may include a touch screen for controlling the operation of the main unit 10. Generally, a touch screen is configured by providing an LCD panel to a rear surface of a touch glass with electrodes printed or vacuum deposited on a surface thereof. Such a touch screen module may be easily configured by those skilled in the art, so that detailed descriptions thereon will be omitted.

A speaker 16 is provided at one side of the case 12. The speaker 16 serves to output a played music or a sound of a moving picture to the outside. Thus, a user may output a voice data through the speaker 16 without any additional voice output device such as an earphone.

A pivoting portion 18 is rotatably provided at one side of the case 12. In order to rotate the pivoting portion 18 with respect to the case 12, certain force should be applied thereto. The auxiliary unit 30, which will be described later, is connected to the pivoting portion 18.

The pivoting portion 18 is connected to the case 12 by a hinge structure using a hinge pin (not shown). Also, the pivoting portion 18 is electrically connected to a main board (not shown) provided in the main unit 10. For example, a wire for signal connection between a component mounted in the case 12 and a terminal insertion portion (not shown) to be described later passes through the hinge pin. A configuration capable of controlling the rotation of the pivoting portion 18 may be provided in surfaces where the case 12 and the pivoting portion 18 are in contact with each other.

The terminal insertion portion (not shown) is provided in the pivoting portion 18 such that a terminal portion 34 to be described later may be inserted in the terminal insertion portion. That is, the auxiliary unit 30 is supported by the pivoting portion 18, and the terminal portion 34 is inserted into the terminal insertion portion to communicate electric signals.

The terminal insertion portion may include various kinds of interfaces to communicate electric signals, but an interface of universal serial bus (USB) standards generally used in the art will be described as an example thereof in this embodiment. The USB interface may be easily configured by those skilled in the art, so that descriptions thereof will be omitted.

A support 20 is provided at one side surface of the case 12. The support 20 is formed at one end opposite to the pivoting portion 18 on the one side surface of the case 12. The support 20 supports the auxiliary unit 30 connected to the pivoting portion 18. That is, the support 20 supports one end of the auxiliary unit 30, which is farthest from the pivoting portion 18 that is a pivot center of the auxiliary unit 30. The support 20 is preferably provided to be elastically deformable with respect to the case 12.

The auxiliary unit 30 is detachably coupled to the pivoting portion 18. The auxiliary unit 30, which is a unit for receiving audio data and playing back it as music, stores music data using a semiconductor memory.

A body 32 configures a framework of the auxiliary unit 30. The body 32 has a substantial rectangular hexahedral shape and is mounted to the side surface of the main unit 10 to define a part of the external appearance of the main unit 10. That is, the auxiliary unit 30 is coupled with the main unit 10 to define a part of the external appearance of the portable digital device. The body 32 corresponds to the pivoting portion 18 in size and shape. The body 32 is partially inserted into the pivoting portion 18.

The components required for operating the device, such as a battery and a board (PCB) having various memories (ROM and RAM) mounted thereon, are provided in the body 32. An edge of the body 32 is preferably formed to be round so that a contact surface of the body 32 with the ground can be changed according to an angle of the auxiliary unit 30 when the auxiliary unit 30 is inserted into the main unit 10 to form a standing structure. A friction member with large friction coefficient, such as rubber, may be provided on a lower end of the body 32 to prevent the body 32 from sliding.

In addition, the lower end of the body 32 is supported by the support 20. A concave portion 32′ and a protrusion 20′ inserted thereinto may be elastically deformably provided at corresponding surfaces of the support 20 and the body 32, which are in contact with each other. This configuration would not allow the body 32 to be easily separated from the support 20. That is, certain external force should be applied to separate the body 32 from the support 20.

The terminal portion 34 is provided at a upper end of the body 32. The terminal portion 34 is inserted into the terminal insertion portion and then electrically connected to the main board provided in the main unit 10. The terminal portion 34 includes an interface capable of communicating electric signals in correspondence with the terminal insertion portion, and a USB interface generally used in the art is used as the terminal portion 34 in this embodiment.

An input portion 36 is provided at one surface of the body 32. The input portion 36 is exposed in the same direction as the display 14 when the auxiliary unit 30 is mounted to the main unit 10. The input portion 36 is a portion for controlling the operation of the main unit 10 and the auxiliary unit 30 and receives various instructions for operating the portable digital device. The input portion 36 may include buttons for controlling input or output, but preferably include a touch pad for a light and compact design of the device.

The input portion 36 selectively controls the operation of the main unit 10 and the auxiliary unit 30. That is, the input portion 36 controls the operation of the main unit 10 when the auxiliary unit 30 is connected to the main unit 10, whereas the input portion 36 controls the operation of the auxiliary unit 30 when the auxiliary unit 30 is separated from the main unit 10. The main unit 10 may include the display 14 of a touch screen type as a separate input means for controlling the operation of the main unit 10, as described above.

An earphone hole (not shown) is formed in the lower end of the body 32, which is opposite to the terminal portion 34. An earphone jack (not shown) is inserted into the earphone hole so that a voice data or a voice signal of an image data is transmitted to a user.

Hereinafter, the operation of the portable digital device so configured according to the present invention will be described in detail.

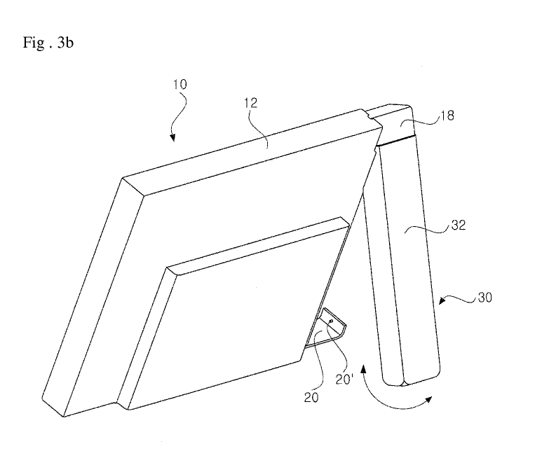

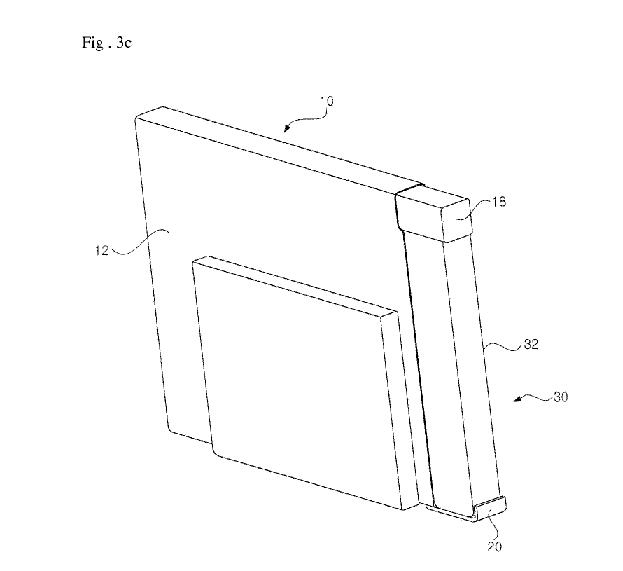

FIGS. 3a and 3c are perspective views showing operation states of the portable digital device according to the preferred embodiment of the present invention.

First, a process of mounting and detaching the auxiliary unit 30 to and from the main unit 10 will be described. The pivoting portion 18 of the main unit 10 is connected to the case 12 in a hinge manner, thereby being rotatable.

As shown in FIG. 3a, a user rotates the pivoting portion 18 by a predetermined angle clockwise or counterclockwise with respect to the support 20. The body 32 provided with the terminal portion 34 is arranged so that its upper end is directed to the pivoting portion 18, and then the upper end is inserted into the pivoting portion 18 in a direction of an arrow A, so that the terminal portion 34 is connected to the terminal insertion portion of the pivoting portion 18. At this time, a part of the body 32 is completely inserted into the pivoting portion 18, and the terminal portion 34 is connected to the terminal insertion portion and transmits electric signals thereto.

FIG. 3b shows that the body 32 is partially inserted into the pivoting portion 18. As such, in a state where the auxiliary unit 30 is connected to the pivoting portion 18, the auxiliary unit 30 is rotated together with the pivoting portion 18 toward the support 20.

If the auxiliary unit 30 is rotated and comes into contact with the protrusion 20′, the support 20 starts to be elastically deformed. At this time, the auxiliary unit 30 rotates while overcoming the elastic force of the support 20, and the protrusion 20′ is inserted into the concave portion 32′ formed in the auxiliary unit 30. The auxiliary unit 30 is finally positioned between the pivoting portion 18 and the support 20. If the body 32 which is inserted into the pivoting portion 18 is supported by the support 20, the auxiliary unit 30 is fixed to the main unit 10. Such a state is shown in FIG. 3c.

A user may control the operation of the main unit 10 by manipulating the input portion 36 provided in the auxiliary unit 30. That is, in a case where the auxiliary unit 30 is connected to the main unit 10, the operation of the main unit 10 is controlled by the input portion 36 provided in the auxiliary unit 30. In addition, when only the auxiliary unit 30 is used, the auxiliary unit 30 may be separated from the main unit 10 and then can be potable. When the auxiliary unit 30 is used independently, the operation of the auxiliary unit 30 is also controlled by the input portion 36.

In order to separate the auxiliary unit 30, the auxiliary unit 30 should be rotated. At this time, the protrusion 20′ formed on the support 20 comes out of the concave portion 32′ formed in the body 32. In this state, if the auxiliary unit 30 is rotated continuously, the lower end of the body 32 is separated from the support 20. Also, force is applied in a direction opposite to the arrow A to separate the auxiliary unit 30 from the pivoting portion 18.

Such a portable digital device outputs a desired data by modulating various multimedia signals such as voice or image into digital signals, and a user may generally use the device when moving by vehicle such as bus or electric railway. However, as practical use of portable digital devices is increased, a portable digital device may be used in a standing state on a table at home or office for a user to watch a moving picture lecture or inquire information.

The portable digital device of this embodiment can be used in a standing state using the auxiliary unit 30 when a user watches a broadcast or the like, which will be described below.

In order to stand the main unit 10 having the auxiliary unit 30 mounted thereto at an optimal angle, the lower surface of the case 12 provided with the support 20 is placed to contact with the ground, as shown in FIG. 3c.

In this state, if the auxiliary unit 30 is rotated together with the pivoting portion 18 clockwise, the support 20 is elastically deformed, and the protrusion 20′ comes out of the concave portion 32′ formed in the body 32. In this state, if the auxiliary unit 30 is rotated continuously, the lower end of the auxiliary unit 30 is separated from the support 20 while overcoming the elastic force of the support 20.

The auxiliary unit 30 the lower end of which is separated from the support 20 is rotated to make a suitable angle with respect to the main unit 10. In order to rotate the pivoting portion 18 with respect to the case 12, certain force should be applied thereto. Thus, if the pivoting portion 18 is rotated, the pivoting portion 18 is not rotated by the self weight of the main unit 10 or the auxiliary unit 30.

If the portable digital device is placed on the horizontal plane while the auxiliary unit 30 makes a predetermined angle with respect to the main unit 10 as mentioned above, the main unit 10 is supported by the auxiliary unit 30 as shown in FIG. 3b.

In such a standing state, a user may utilize functions of the main unit 10 by manipulating the input portion 36 provided in the auxiliary unit 30. The portable digital device having such a standing structure by the auxiliary unit 30 as mentioned above does not need any space for installing am additional support and also ensures convenient manipulations.

Now, another embodiment of the portable digital device according to the present invention will be described in detail with reference to the accompanying drawings.

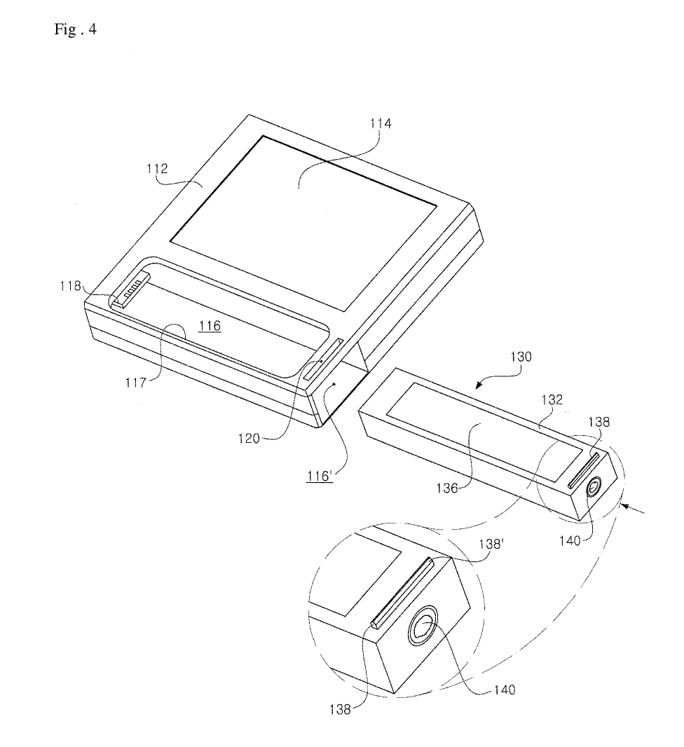

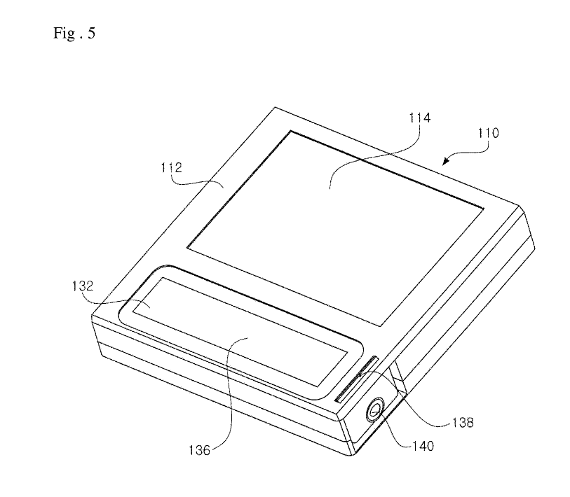

FIGS. 4 and 5 are perspective views showing the other embodiment of the portable digital device according to the present invention.

In this embodiment, a structure for mounting an auxiliary unit to a main unit is different from the previous embodiment. Detailed description of components identical with those of the embodiment shown in FIGS. 1 and 2 will be omitted. In this embodiment, reference numerals increased by one hundred are given to the same elements as the previous embodiment

According to the figures, a portable digital device of this embodiment generally includes a main unit 110 and an auxiliary unit 130.

A case 112 defining an external appearance of the main unit 110 has a substantially hexahedral shape. The case 112 is provided with circuit components required for operating the device, such as various memories (ROM and RAM), an interrupt controller and a battery.

A display 114 having a substantially tetragonal shape is provided in a front surface of the case 112. The display 114 has an LCD panel and the like provided in the case 112, and a portion thereof is transparent such that contents displayed on the LCD panel may be viewed on the front of the case 112. The display 114 displays an operational state of the portable digital device or an image played by the execution of a multimedia file.

The main unit 110 may have an additional input portion for controlling the operation of the main unit 110. This input portion may include a touch pad or a button array having buttons for manipulation, and the display 114 may also be used as the input portion. For example, the display 114 may include a touch screen for controlling the operation of the main unit 110. Generally, a touch screen is configured by providing an LCD panel to a rear surface of a touch glass with electrodes printed or vacuum deposited on a surface thereof. Such a touch screen module may be easily configured by those skilled in the art, so that detailed descriptions thereon will be omitted.

An insertion space 116 is formed in a lower portion of the case 112 so that the insertion space 116 is open toward the front surface of the case 112. An entrance 116′ is formed in one side of the lower portion of the case 112 where the insertion space 116 is formed. The entrance 116′ is formed corresponding to the auxiliary unit 130 to be described later in size and shape so that the auxiliary unit 130 may be inserted therein.

A display window 117 is formed in the front surface of the case 112 where the insertion space 116 is formed. The display window 117 is formed on an extension plane of the display 114, thereby communicating with the insertion space 116. When the auxiliary unit 130 is inserted into the insertion space 116, an input portion 136 that is formed on a body 132 to be described later is exposed to the outside through the display window 117.

A terminal insertion portion 118 is provided at the other side of the lower portion of the case 112 where the insertion space 116 is formed. The terminal insertion portion 118 is electrically connected to a main board (not shown) provided in the main unit 110. The terminal insertion portion 1 18 may include various kinds of interfaces to communicate electric signals, but an interface of USB standards generally used in the art will be described as an example thereof in this embodiment. A terminal portion (not shown) of the auxiliary unit 130 to be described later is inserted into the terminal insertion portion 118.

A fixing slot 120 is elongatedly formed in one side of the case 112 opposite to the terminal insertion portion 118. The fixing slot 120 communicates with the insertion space 116. A region of the case 112 around the fixing slot 120 is made of an elastically deformable material. A catching portion 138, which will be described later, is inserted into the fixing slot 120.

An input portion 136 is provided at the body 132 defining an external appearance of the auxiliary unit 130. When the auxiliary unit 130 is mounted to the main unit 110, the input portion 136 is exposed to the outside through the display window 117 so that the input portion 130 is oriented in the same direction as the display 114. The input portion 136 is a portion for controlling the operation of the main unit 110 and the auxiliary unit 130 and receives various instructions for operating the portable digital device. The input portion 136 may include buttons for controlling input or output, but preferably include a touch pad for a light and compact design of the device.

The terminal portion (not shown) is provided at one end of the body 132 in correspondence to the terminal insertion portion 118. The terminal portion is inserted into the terminal insertion portion 118 and communicates electric signals between the main unit 110 and the auxiliary unit 130.

The catching portion 138 is formed to protrude on one side of the body 132 corresponding to the fixing slot 120. Both elongated sides of the catching portion 138 are formed with a predetermined slope to form a chamfer 138′. The chamfer 138′ serves to guide the catching portion 138 into the fixing slot 120 when the body 132 is inserted into the insertion space 116. Of course, the chamfer 138′ also guides the catching portion 138 to be separated from the fixing slot 120 when the body 132 is drawn out of the insertion space 116. The catching portion 138 serves to fix the body 132 so that the auxiliary 130 may not be easily drawn out of the insertion space 116. When the auxiliary unit 130 is drawn out of the insertion space 116, a region around the fixing slot 120 is elastically deformed, so that the body 132 may be separated from the insertion space 116.

An earphone hole 140 is formed in the body 132 at a position adjacent to the catching portion 138. An earphone jack (not shown) is inserted into the earphone hole so that a voice data or a voice signal of an image data is transmitted to a user.

Hereinafter, the operation of the portable digital device so configured according to the present invention will be described in detail.

The body 132 of the auxiliary unit 130 is inserted into the open insertion space 116 formed in the main unit 110 through the entrance 116′. That is, the end of the body 132 having the terminal portion is inserted into the insertion space 116 opened in the side of the case 112.

At this time, the region of the case 112 around the fixing slot 120 is elastically deformed due to the insertion of the body 132, and the catching portion 138 is guided by the chamfer 138′ and inserted into the fixing slot 120.

If the catching portion 138 is inserted into the fixing slot 120, the body 132 is fixed in the insertion space 116. If the body 132 is completely inserted into the insertion space 116, the terminal portion is inserted into the terminal insertion portion 118 to communicate electric signals.

A user may control the operation of the main unit 110 by manipulating the input portion 136 provided in the auxiliary unit 130. That is, in a case where the auxiliary unit 130 is connected to the main unit 110, the operation of the main unit 110 is controlled by the input portion 136 provided in the auxiliary unit 130. In addition, when only the auxiliary unit 130 is used, the auxiliary unit 130 may be separated from the main unit 110 and then can be potable. When the auxiliary unit 130 is used solely, the operation of the auxiliary unit 130 is also controlled by the input portion 136.

In order to separate the auxiliary unit 130, force should be applied to the auxiliary unit 130 in a direction opposite to the inserting direction of the body 132. At this time, the region around the fixing slot 120 is elastically deformed, and the catching portion 138 is separated from the fixing slot 120.

In addition, if the terminal portion is separated from the terminal insertion portion 118, the main unit 110 and the auxiliary unit 130 are electrically disconnected from each other. The auxiliary unit 130 is finally separated from the insertion space 116 and drawn out.

A user may carry only the auxiliary unit 130 separated from the main unit 110 and outputs voice data from the auxiliary unit 130. Since the auxiliary unit 130 may be used as being separated from the main unit 110 having a large capacity battery for playback of an image, there is an advantage in that portability is improved. Of course, if playback of image data is needed, the auxiliary unit 130 may also be used as being mounted to the main unit 110.

As described above, in a state where the main unit 10 or 110 is connected to the auxiliary unit 30 or 130, the auxiliary unit 30 or 130 controls the operation of the main unit 10 or 110. Hereinafter, a process of controlling the main unit 10 or 110 by the auxiliary unit 30 or 130 will be described in detail with reference to the accompanying drawings.

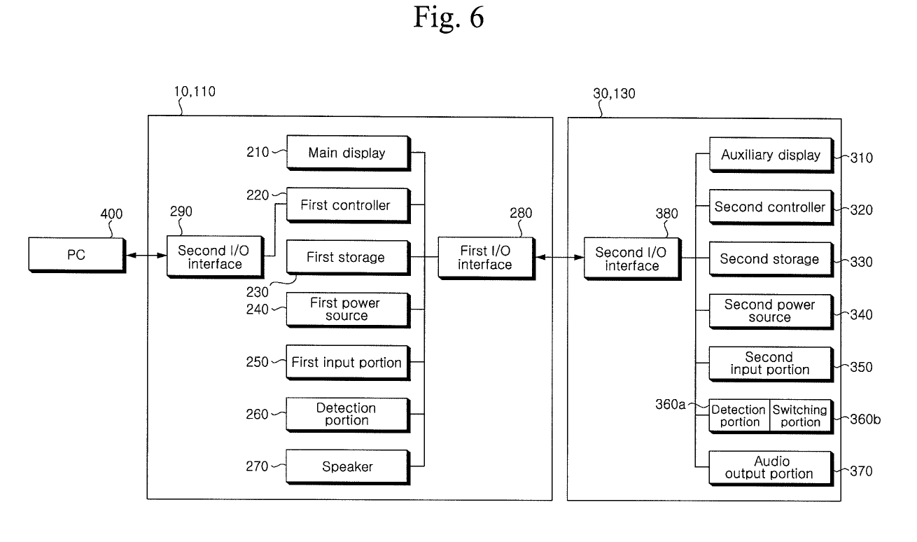

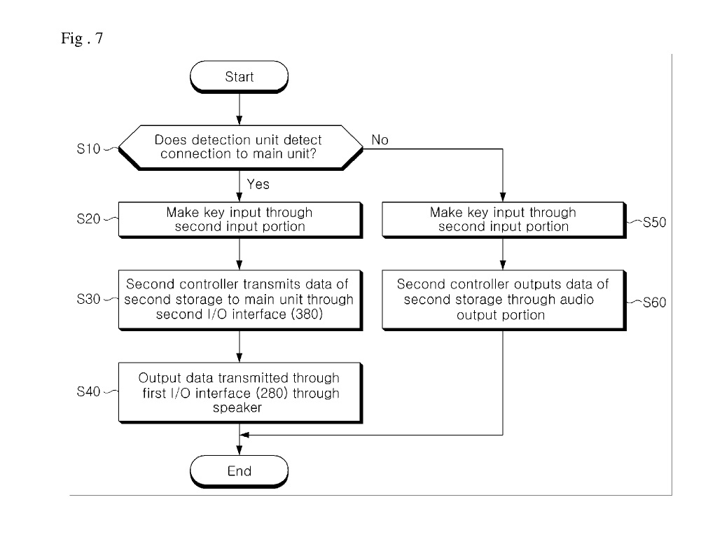

FIG. 6 is a block diagram of the main unit and the auxiliary unit of the portable digital device according to the present invention, and FIG. 7 is a flowchart illustrating that the main unit is controlled by the auxiliary unit in the embodiment of the present invention.

According to the figures, the main unit 10 or 110 includes a main display 210, a first controller 220, a PC I/O interface 225, a first storage 230, a first power source 240, a first input portion 250, a detection portion 260, a speaker 270, and first and second I/O interfaces 280 and 290. In addition, the auxiliary unit 30 or 130 includes an auxiliary display 310, a second controller 320, a second storage 330, a second power source 340, a second input portion 350, a detection portion 360a, a switching portion 360b, an audio output portion 370, and a second I/O interface 380.

In a state the auxiliary unit 30 or 130 is coupled to the main unit 10 or 110, the main display 210 of the main unit 10 or 110 displays a list of files to be played back in connection with the second input portion 350, and also displays a moving picture to a user. An LCD is generally used as the main display 210.

The first controller 220 controls playback of various music or moving picture files in a state where the main unit 10 or 110 is separated from the auxiliary unit 30 or 130. The first storage 230 stores large capacity multimedia data such as text, music, movie files. Such multimedia data are downloaded from a PC 400 through the second I/O interface 290, which will be described later.

The first power source 240 corresponds to a main battery of the portable digital device. Thus, the main unit 10 or 110 is driven by the first power source 240 when the auxiliary unit 30 or 130 is coupled to the main unit 10 or 110, while the second power source 340 independently supplies the auxiliary unit 30 or 130 with power when the auxiliary unit 30 or 130 is separated from the main unit 10 or 110.

In addition, a user makes key input through the first input portion 250, and the detection portion 260 detects whether the auxiliary unit 30 or 130 is coupled or separated. Also, the speaker 270 takes charge of outputting voice signals.

The first and second I/O interfaces 280 and 290 serve to allow various control signals and power lines for control of the main unit 10 or 110 to be received from and transmitted to the auxiliary unit 30 or 130 and the PC 400 through the I/O interfaces.

Then, the auxiliary display 310 displays a music file or the like to be played back by the auxiliary unit 30 or 130. An LCD is generally used as the auxiliary display 310.

The second controller 320 allows a file to be played back or audio data to be output to the main unit 10 or 110 through the second I/O interface 380 in a state where the auxiliary unit 30 or 130 is coupled with the main unit 10 or 110. Of course, in a state where the auxiliary unit 30 or 130 is separated from the main unit 10 or 110, the second controller 320 controls the playback of a file in the auxiliary unit 30 or 130.

The second storage 330 stores audio files, programs related to initialization of the portable digital device and various application programs unlike the first storage 230 with a large capacity.

The second power source 340 supplies power to the auxiliary unit 30 or 130 in a state where the auxiliary unit 30 or 130 is separated from the main unit 10 or 110.

A user makes key input through the second input portion 350. In addition, the detection portion 360a and the switching portion 360b serve to detect the connection between the main unit 10 or 110 and the auxiliary unit 30 or 130. If the auxiliary unit 30 or 130 is separated from the main unit 10 or 110, the detection portion 360a and the switching portion 360b detect the separation and transmits a corresponding signal to the second controller 320 and are also supplied with necessary power from any one of the power sources 240 and 340.

Meanwhile, the audio output portion 370 outputs an audio data file stored in the second storage 330. That is, the audio output portion 370 outputs an audio data file when the auxiliary unit 30 or 130 is separated.

According to such a configuration, the detection portion 360a of the auxiliary unit 30 or 130 detects whether the main unit 10 or 110 is connected (Step S10). According to the detection of the detection portion 360a, the switching portion 360b informs the second controller 320 of whether the auxiliary unit 30 or 130 is connected to the main unit 10 or 110.

If the detection portion 360a detects the connection to the main unit 10 or 110, a user is allowed to make key input through the second input portion 350 (S20). The information input through the second input portion 350 should be not used for operating the auxiliary unit 30 or 130 but transmitted to the main unit 10 or 110. That is, the second controller 320 transmits an audio data or the like of the second storage 330 to the main unit 10 or 110 through the second I/O interface 380 (Step S30).

Information of audio data or the like is transmitted to the first I/O interface 280 through the second I/O interface 380, and the audio data transmitted to the first I/O interface 280 is output through the speaker 270. In addition, if a stop instruction is input to the second input portion 350 by a user, the second controller 320 outputs the stop instruction to the main unit 10 or 110 through the first and second I/O interfaces 280 and 380, thereby making the speaker 270 stop its outputting operation (Step S40).

If the detection portion 360a of the auxiliary unit 30 or 130 detect that the main unit 10 or 110 is not detected (Step S10), the user is allowed to make key input through the second input portion 350 (Step S50). Then, the second controller 320 outputs an audio data or the like of the second storage 330 through the audio output portion 370 (Step S60).

According to the embodiment, the auxiliary unit can be separated from the main unit, which is large in weight and volume due to a large capacity battery, and then used alone as required, so that there is an advantage in that portability is improved.

In addition, the portable digital device of the embodiment, in which the auxiliary unit is rotatably coupled to the main unit, may allow the auxiliary unit to be rotated together with the pivoting portion connected to the main unit and thus can stand on a table or the like, thereby enhancing convenience to a user.

The scope of the embodiment is not limited to the embodiments described above but is defined by the appended claims. It will be apparent that those skilled in the art can make various modifications and changes thereto within the scope of the invention defined by the claims.

What is claimed is:

1. A portable digital device, comprising:
a main unit including a display provided on the main unit and a terminal insertion portion; and
an auxiliary unit including a terminal portion configured to be electrically connectable to the terminal insertion portion to allow communication between the main unit and the auxiliary unit, the auxiliary unit being configured to control operation of the main unit when being mounted to the main unit, the auxiliary unit being capable of independently reproducing audio and/or video data when being separated from the main unit.

2. The portable digital device as claimed in claim 1, wherein the auxiliary unit is provided with an input portion configured to control operation of the main unit.

3. The portable digital device as claimed in claim 2, wherein a touch pad is provided in the input portion to selectively control operation of the main unit and/or the auxiliary unit.

4. The portable digital device as claimed in claim 1, wherein
the main unit further includes a pivoting portion pivotally provided at the main unit, the pivoting portion being provided with the terminal insertion portion, and
the auxiliary unit is engagable with the pivoting portion via the terminal insertion portion and the terminal portion, the auxiliary unit pivotally rotating together with the pivoting portion when the auxiliary unit engages with the pivoting portion.

5. The portable digital device as claimed in claim 4, wherein a support is provided at the main unit to support the auxiliary unit at a position farthest from the terminal portion of the auxiliary unit.

6. The portable digital device as claimed in claim 5, wherein the support is made of an elastically deformable material.

7. The portable digital device as claimed in claim 6, wherein a concave portion and a protrusion inserted into the concave portion are respectively formed in corresponding surfaces of the support and a body of the auxiliary unit that are in contact with each other.

8. The portable digital device as claimed in claim 7, wherein an edge of a lower end of the body supported by the support is substantially round, and a friction member is provided at the lower end of the body to prevent the body from sliding off the support.

9. The portable digital device as claimed in claim 1, wherein
the main unit includes an insertion space provided at the main unit, the insertion space having an opening and the terminal insertion portion; and
the auxiliary unit is slidably insertable into the insertion space through the opening to connect the terminal portion with the terminal insertion portion.

10. The portable digital device as claimed in claim 9, wherein
the auxiliary unit is provided with an input portion configured to control operation of the main unit, and
the insertion space is provided with a window through which the input portion is shown when the auxiliary unit is mounted to the main unit.

11. The portable digital device as claimed in claim 10, wherein the insertion space includes a fixing slot engagable with a catching portion of the auxiliary unit to fix the auxiliary unit in the insertion space when the auxiliary unit is inserted into the insertion space.

12. The portable digital device as claimed in claim 11, wherein an area around the fixing slot is made of an elastically deformable material.

13. The portable digital device as claimed in claim 1, wherein the terminal insertion portion is a universal serial bus (USB) interface.

14. The portable digital device as claimed in claim 1, wherein the auxiliary unit further comprises:
an I/O interface configured to communicate with the main unit;
a controller configured to control the audio and/or video data to be reproduced by the auxiliary unit if the auxiliary unit is not connected to the main unit or to control the audio and/or video data to be output to the main unit if the auxiliary unit is connected to the main unit;
a storage configured to store the audio and/or video data;
a power source configured to supply power to the auxiliary unit;
an auxiliary display configured to display a status of the audio and/or video data; and
an audio output portion configured to output an audio signal.

15. The auxiliary unit as claimed in claim 14, further comprising:
a detection portion configured to detect whether the auxiliary unit is connected to the main unit;
a switching portion configured to detect a separation of the auxiliary unit and the main unit and to transmit a corresponding signal to the controller;

16. The portable digital device as claimed in claim 1, wherein the main unit further comprises:
a first I/O interface configured to communicate with the auxiliary unit;
a second I/O interface configured to communicate with a computer;
a controller configured to control the audio and/or video data to be reproduced by the main unit if the auxiliary unit is not connected to the main unit;
a storage configured to store the audio and/or video data;
a power source configured to supply power to the main unit;
an input portion configured to receive a input by a user;
a detection portion configured to detect whether the auxiliary unit is connected to the main unit; and
a speaker configured to output an audio signal.

17. An auxiliary device for a portable digital device including a main unit, the auxiliary device comprising:
a terminal portion configured to electrically connect the auxiliary device with the main unit via a terminal insertion portion of the main unit, so as to enable communication between the auxiliary device and the main unit;
an input portion configured to receive a user input to control operation of the main unit;
a detection portion configured to detect whether the auxiliary device is connected to the main unit;
a switching portion configured to detect a separation of the auxiliary device and the main unit and to transmit a corresponding signal to a controller of the auxiliary device,
wherein the auxiliary device is configured to control the operation of the main unit when the auxiliary device is connected with the main unit, and
wherein the auxiliary device is capable of independently reproducing audio and/or video data when the auxiliary device is separated from the main unit.

18. The auxiliary device as claimed in claim 17, further comprising:
an I/O interface configured to communicate with the main unit; and
a controller configured to control the audio and/or video data to be reproduced by the auxiliary device if the auxiliary device is not connected to the main unit or to control the audio and/or video data to be output to the main unit if the auxiliary device is connected to the main unit,
a storage configured to store audio and/or video data;
a power source configured to supply power to the auxiliary device;
an auxiliary display configured to display a status of the audio and/or video data; and
an audio output portion configured to output the audio data.

19. A main device for a portable digital device including an auxiliary unit, the main device comprising:
a display configured to reproduce a video signal;
a speaker configured to output an audio signal;
a terminal insertion portion configured to electrically connect the main device with the auxiliary unit via a terminal portion of the auxiliary unit, so as to enable communication between the main device and the auxiliary unit;
a detection portion configured to detect whether the auxiliary unit is connected to the main device; and
connection means including the terminal insertion portion, the connection means being configured to fix the auxiliary unit to the main device when the terminal insertion portion is connected with the terminal portion,
wherein an operation of the main device is controllable by the auxiliary unit when the main device is connected with the auxiliary unit, and
wherein the main device is capable of reproducing audio and/or video data from the auxiliary unit when the main device is connected with the auxiliary unit.

20. A method of operating a portable digital device having a main unit and an auxiliary unit, comprising:
detecting, by the auxiliary unit, whether the main unit is connected to the auxiliary unit;
transmitting audio and/or video stored in the auxiliary unit to a first I/O interface of the main unit through a second I/O interface of the auxiliary unit and reproducing, by the main unit, the transmitted audio and/or video data according to a control signal from the auxiliary unit, if the main unit is connected to the auxiliary unit; and
reproducing, by the auxiliary unit, the audio and/or video data stored in the auxiliary unit according to a user input signal to the auxiliary unit, if the main unit is not connected to the auxiliary unit.

21. The method as claimed in claim 20, further comprising:
ceasing to transmit the audio and/or video data of the auxiliary unit to the first I/O interface of the main unit when a stop signal is sent from the auxiliary unit to the main unit.
